(19) United States
(12) Patent Application Publication
(10) Pub. No.: US 2005/0204393 A1
(43) Pub. Date: Sep. 15, 2005

(54) Home network server

(76) Inventors: Rajendra A. Bopardikar, Phoenix, AZ (US); Gary R. Palangian, Mesa, AZ (US); Gadiraju Narasimham, Portland, OR (US); Steven D. Williams, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/798,697

(22) Filed: Mar. 10, 2004

(51) Int. Cl. H04N 7/18; G06F 17/00; G06F 7/00

(52) U.S. Cl. 725/81; 725/80

(57) ABSTRACT

A method and system for a discoverable transcoder server to communicatively couple to a media server to receive media signals from the media server. The transcoder server transparently converts the media signals to a format compatible with at least one media renderer, and the transcoder server transmits the converted signals to the at least one media renderer.

### BACKGROUND

1. Technical Field

Specific matter disclosed herein relates to the field of servers in a home network.

2. Background Information and Description of Related Art

Home networking has become the environment for creating a digital home. By “digital home” is often meant a home in which home networking is utilized to implement home entertainment distribution systems that include digital media sharing with different types of media files having different media file-formats. Some of the common media files/media file-formats used in today's home networks are audio, video, and picture. For example, media files (e.g., MPEG (Moving Picture Experts Group) files) may have different formats, e.g., video file-formats include, among others, “MPEG1 layer 4”, “WMV” (Windows Media Video), etc.; audio file-formats include, among others, “MP3” (MPEG1 layer 3), “WMA” (Windows Media Audio), etc.; and picture file-formats include, among others, “JPEG” (Joint Photographic Experts Group), “PNG” (Portable Network Graphics), “GIF” (Graphics Interchange Format), etc.

One significant problem facing establishing a digital home is getting data format interoperability or compatibility between digital home devices. One solution, of course is to mandate a single file format, e.g., MPEG-2 as the standard video format. In such a home network, a media server is only able to advertise content if it is available in MPEG-2 format. This is limiting usefulness of the digital home.

### BRIEF DESCRIPTION OF DRAWINGS

The invention may best be understood by referring to the following description and accompanying drawings that are used to illustrate embodiments of the invention. In the drawings:

FIG. 1 is a diagram of a home network having a media server that communicates with a transcoder server for communication with at least two media renderers according to an exemplary embodiment of various aspects according to principles of the present invention.

FIG. 2 is a diagram of the transcoder server of FIG. 1.

FIG. 3 illustrates one embodiment of a home network operating with a media server that is operating according to principles of the exemplary embodiment of FIG. 1.

FIG. 4 illustrates another embodiment of a home network operating with a media server that is also operating according to various aspects of the exemplary embodiment of FIG. 1.

### DETAILED DESCRIPTION

In the following description, specific matter disclosed herein relates to the field of home networking for a system and method for a transcoding and/or transrating server. Transrating is changing the bit-rate of a streaming media to match the new data format. According to disclosed embodiments, a transrating or transcoding server may be discovered, configured, and controlled over a home network. By discovery, it is meant that by way of a discovery protocol such as Universal Plug and Play (UPnP), Jini (see, e.g., Internet Uniform Resource Locator (URL) www-jini-org), Salutation (see, e.g., URL www-salutation-org), or the like, the server will be recognized in the home network as a transcoding device on the home network. (Please note that in the preceding URLs, URL periods have been replaced with dashes to prevent inadvertent hyperlinks.)

Specific details of exemplary embodiments of the present invention are set forth below. However, upon viewing the present disclosure, it should be understood by those of ordinary skill in the art that embodiments of the inventive concepts described herein may be implemented using circuits, structures, and techniques that may or may not have been described herein. Among other things, disclosed herein are embodiments that provide the appearance of a common shared data format on a digital home network while in actuality transcoders/raters are used to simulate the common format.

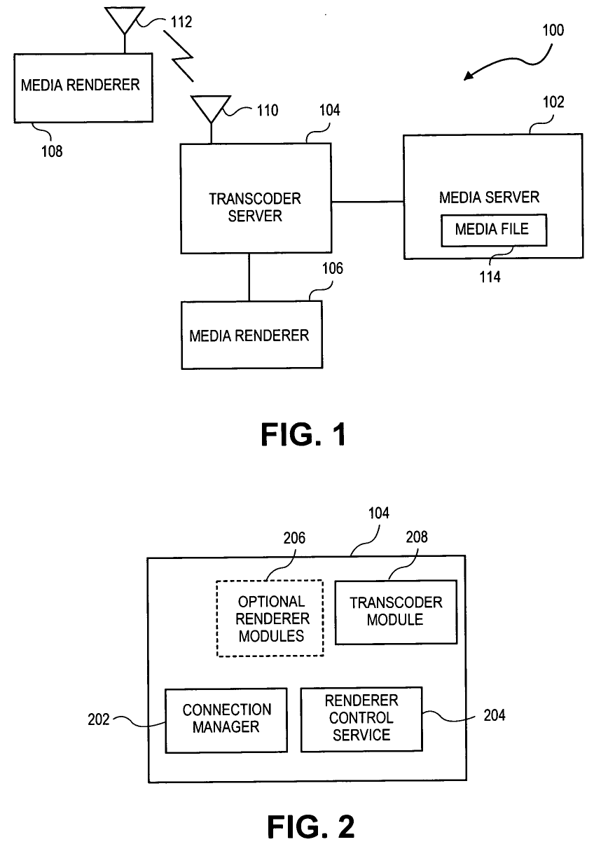

FIG. 1 is a diagram of a home network 100 having a media server 102 that communicates with a transcoder server 104 for communication with at least two media renderers 106, 108 according to an exemplary embodiment. A “media renderer” as referred to herein relates to a device for rendering media signals that are received from a media server or the like. However, this is merely an example of a media renderer, and embodiments of the present invention are not limited in these respects. The transcoder server 104 may be discoverable and is illustrated having an antenna 110 for communication on the home network 100 with an antenna 112 of the media renderer 108.

For purposes of fully appreciating the present disclosure, exemplary operations of the home network 100 are described herein. For example, a media renderer 106 may request that a particular media file 114 be retrieved from the media server 102. A “media file” as referred to herein is a file that contains media information in a particular media format. The media file may be located on a host processing system and accessed by a network software memory program for creation of media signals that will be recognized by a media renderer such as the media renderer 106. However, this is merely an example of a media file, and embodiments of the present invention are not limited in these respects.

A “processing system” as discussed herein generally relates to a combination of hardware and software resources for accomplishing computational tasks, e.g., executing machine-readable instructions of a storage medium with appropriate logic. Hence, a “host processing system” relates to a processing system which may be adapted to communicate with a “peripheral device.” For example, a peripheral device may provide inputs to or receive outputs from an application process hosted on the host processing system. However, these are merely examples of processing systems and a peripheral device, and embodiments of the present invention are not limited in these respects.

After the media file 114 is requested by the media renderer 106, the media server 102 may then transmit the media file 114 to the media renderer 106. Upon transmission, signals representing the media file 114 pass through the transcoder server 104 where, transparent to both the media server 102 and the media renderer 106, the media file signals may be converted to the media file format of the media renderer 106 if conversion is necessary. Thus, the transcoder server 104 allows the media renderer 106 to recognize the media file 114 regardless of the original media format of the media file 114. As will be appreciated, the transcoder server 104 allows the media server 102 to operate with similar processing functionality regardless of the particular type of media renderer that requested the media file 114.

For example, the media renderer 106 could be a speaker (digital speaker/audio card, not shown) that recognizes only WMA format audio signals for transmitting audio signals to a listener of music. If the media file 114 produces only MP3 format audio signals, the transcoder server 104 must convert the MP3 signals to WMA format prior to the signals reaching the media renderer 106.

In a like manner, the media renderer 106 could also be a video display for displaying a visual image to a viewer of a picture or video that the media file 114 represents, e.g., a flat panel monitor, a liquid crystal display screen, a plasma screen television display, or a high definition television display. In addition, the media renderer 106 could be a video display/speaker combination (digital or otherwise) for a user to view a movie that the media file 114 represents. As illustrated, there are two media renderers 106, 108 connected to the transcoder server 104. Media renderer 106 is connected via a wired network segment; while media renderer 108 is connected via a wireless network segment. Although not required, both media renderers 106, 108 may exist on the home network 100 and for operation may each require receiving media signals from the media file 114 in different media formats. Due to potential conversions at the transcoder server 104, each media renderer 106, 108 is able to operate in the home network 100 as though the media file 114 would generate media signals in a format suited to the particular display.

Still further, the media renderer 106 may be incorporated by a client of the home network 100, e.g., a module in a web browser. The client may be a graphical user interface (GUI) that contacts the media server 102 with a network application program that supports a first media file format. The client may then receive a list of available media renderers having associated encoding formats, and select a media renderer from the list. If the selected media renderer is encoded in a format unsupported by the first media file format of the network application program, the selected media renderer may be converted to recognize the first media file format and the converted media renderer may be provided to the network application program.

As the media server 102 may be configured to discover the home network transcoder server 104, and as the media server 102 may be responsive to selecting the media renderer with a second media file format, the selected media renderer may be provided to the transcoder server 102 where the transcoder server 102 may be configured to convert the selected media renderer to the first media file format and provide the converted media renderer to the network application program.

As described in greater detail herein, in the wireless embodiment of the media renderer 108, the transcoder server 104 may operate to convert MPEG2 signals to MPEG4 signals in order to most effectively utilize available bandwidth in the home network 100. It will be appreciated by one skilled in the art that MPEG4 is indicated for exemplary purposes only and that embodiments contemplate other currently available bandwidth conserving data formats and/or protocols developed in the future.

The present disclosure, among other things, discloses a home network server capable of transcoding at least audio/video entertainment content. Transcoding is the technique of converting a media file from one format to another. The home network server may also be capable of (near) real-time transcoding and transrating of at least audio/video entertainment content. Transcoding is the technique of converting a media stream from one format to another. As stated at least in part above, one aspect of the disclosed transcoding/transrating servers is that they may be discovered, configured and controlled via home-networking frameworks.

As described in more detail below, a home network server capable of transcoding enables improved data-format interoperability. Further, a server that may be transparently discovered, configured and controlled readily fits into emerging home-networking frameworks. If a networked transcoding server is available, then a media server may be able to advertise the content that is not in the existing format, by converting it into the desired format via the transcoding server. Still further, a networked transrating and transcoding server allows a media server to advertise content that is not in the MPEG-2 format. This content may be converted into the desired format, in real time or near real-time, when a renderer requests this content.

FIG. 2 is a diagram of the transcoder server 104 shown in more detail. The transcoder server 104 may be realized in hardware or as a software program, and may or may not be part of a standard personal computer. The transcoder server 104 includes a connection manager 202, a renderer control service 204, and optional renderer modules 206. A “module” as referred to herein may be considered to be a program, a software program, a media file, or other type of machine-readable instruction set that may be stored in a storage medium or the like.

For example, a “transrating module” as referred to herein, which is an example of one of the optional renderer modules 206, may be located in a storage medium that includes an instruction set executable to perform transrating services, or the transrating module could refer to a combination of logic and/or a programmable hardware element or combination thereof as will be understood by those of ordinary skill in the art and viewing the present disclosure. However, these are merely examples of modules, and embodiments of the present invention are not limited in these respects.

Although not illustrated in detail, those of ordinary skill in the art and viewing the present disclosure should understand the transcoder functionality such as the rendering hardware (not shown) may be an audio adapter card for rendering sound from the media file 114 (e.g., the media file 114 may be an audio file in a format such as MP3 or WMA). The transcoder server 104 also includes transcoder module 208 which may be a hardware module, a software module, a firmware module, or other module familiar to those of ordinary skill in the art and viewing the present disclosure. The module may be configured to perform the disclosed aspects of embodiments according to principles of the present invention. The transcoder module 208 allows the transcoder server 104 to receive signals from the media server 102 and, transparently to the requesting media renderers 106, 108 and the media server 102, convert those signals into the media format of the requesting media renderer 106,108 as requested, and then transmit those signals according to the media format that the media renderer 106, 108 requested.

For example, the media renderer 108 may be a wireless television center that has requested a movie from the media server 102. The media file 114 may produce an MPEG2 media stream from the media file 114 which is to be sent to the media renderer 108 by way of the transcoder server 104. The transcoder server 104 may be configured to recognize that the MPEG2 signals are better suited as MPEG4 signals due to the wireless transmission to the media renderer 108, and transparently to the media server 102 and the media renderer 108, the transcoder server 104 converts the MPEG2 signals to MPEG4 via the transcoder server 104 prior to being transmitted to the media renderer 108.

As stated, the transcoder server 104 may be a discoverable device and/or the transcoder server 104 may be located within a personal computer as a software program, or may be a separate hardware entity configured separately from the media server 102 as illustrated. Further, the transcoder server 104 may be another combination of hardware, software, and firmware, as will be understood by those of ordinary skill in the art and viewing the present disclosure.

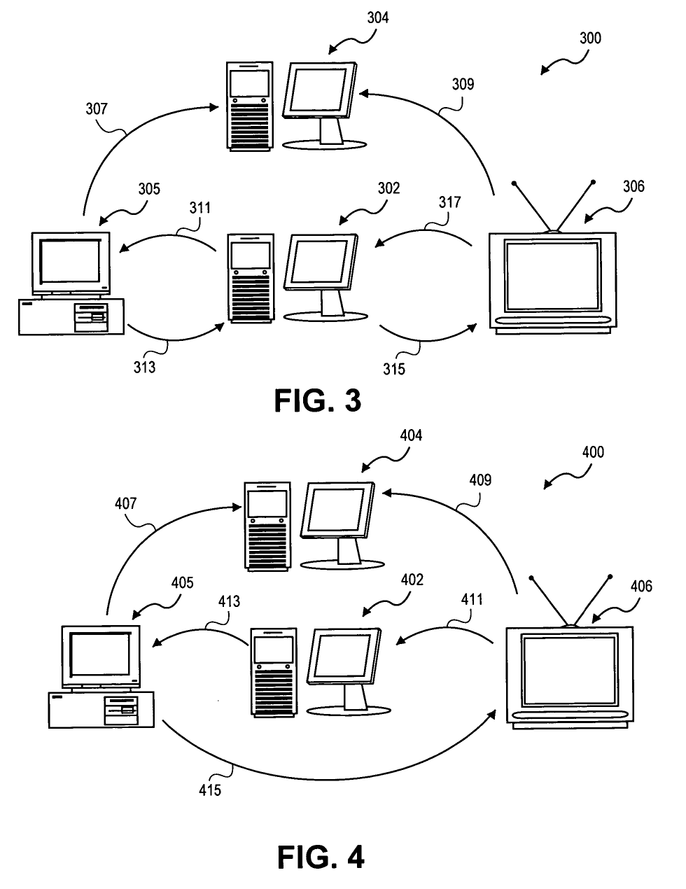

FIG. 3 illustrates one embodiment of a home network 300 operating with a media server 302 that functions according to the exemplary embodiment of the home network 100. In operation, as indicated by arrows 307 and 309, a control point 304 of the home network 300 may discover a transcoding server 305 and a media renderer 306. As shown by other arrows 311 and 313, the media server 302 may transmit media content to the transcoding server 305 in one format, e.g., WMV format, and the transcoding server 305 may then return the media content to the media server 302 in another format, e.g., MPEG2 format. These conversions are performed to prepare/convert media files for transmission 315 to a potentially requesting 317 media renderer. It will be appreciated that MPEG and WM formats are used for illustrative purposes only, and the illustrated embodiment is, of course, applicable to other media formats.

The media renderer 306 may request 317 an MPEG2 file from the media server 302 and the media server 302 is able to transmit (“stream”) 315 the MPEG2 format file from the media server 302 to the media renderer 306 because the WMV format media signals had been previously converted by the transcoding server 305. The transcoding server 305 may convert all new signals from media files to a format compatible with the media renderer 306, or the transcoding server 305 may wait until the media file is requested 317 by the media renderer 306. Regardless, conversion at the transcoding server 305 occurs transparently to the media server 302 and the media renderer 306. As illustrated, the transcoding server 305 may or may not stand alone.

In other words, the transcoding server 305 may be used to convert an available media file into a different format, in advance, even before the file is requested 317 in that format by the media renderer 306. This can be achieved by monitoring the contents of the media server 302, and initializing transcoding as soon as new content becomes available on the media server 302. Once the transcoding server 305 returns the file in the desired format to the media server 302, the media server 302 may store the file and advertise it to the renderer 306 through standard mechanisms such as browse and search. Media server 302 content may be converted for other reasons as well.

Transrating is the technique of adjusting the streaming media bit rate as per the file format. Thus, transrating may not be needed in this scenario because the transcoding server is not a part of the real-time media streaming. Although it may be desirable to eliminate the network and processing overhead caused by transrating a file into another format without any regard to whether or not this action is necessary, the scheme of FIG. 3 may be desirable when the transcoding server 305 does not need to provide a real-time service.

FIG. 4 illustrates another embodiment of a home network 400 operating with a media server 402 that is also operating according to the exemplary embodiment of the home network 100. In operation, similar to FIG. 3, as indicated by arrows 407 and 409, a control point 404 of the home network 400 may discover a transcoding server 405 and a media renderer 406. As shown by other arrow 411, the media renderer 406 may request an MPEG2 file from the media server 402. The media server 402 may then transmit the requested media file by transmitting 413 corresponding WMV content signals from an available media file to the transcoding server 405. The transcoding server 405 transcodes the WMV signals to MPEG2 format and then transrates the signals so that the media content signals may be streamed 415 to the media renderer 406 at the appropriate bit rate in the requested MPEG2 format. As will be understood by one of ordinary skill in the art upon viewing the present disclosure, computing cycles are saved and network bandwidth is made available when transcoding server 405, unlike transcoding server 305, operates at or near real-time as a transcoding and transrating server and the media content signals are transcoded into another format only if necessary.

In FIG. 4, the transcoding takes place in at or near real-time. The audio/video stream between the media-server 402 and the media renderer 406 is redirected to flow via the transcoding server 405 where transrating also takes place. The transcoding server 405 manipulates the media content format and the bit-rate in near real-time. In this embodiment, the media server 402 broadcasts a particular media format that may be available although the media content may not reside on the media server 402 in that format. The discovery/description process allows the control point 404 to discover the existence of the transcoding server 405 on the network 400 along with the capabilities of the transcoding server 405, e.g. the source and target file formats for transcoding and transrating services.

In the foregoing description, various terms and phrases have been used and occasionally defined. These terms and phrases are intended to be broadly interpreted unless context or incident explanation or definition requires a narrow interpretation. The following list is a glossary highlighting certain terms and phrases related to those that may or may not have been utilized above. This list is not intended to be exhaustive; rather it is simply an exemplary list of terms whose definition may facilitate fully appreciating the present description.

The term “program” is intended to have the full breadth of its ordinary meaning. The term ‘program’ includes a software program which may be stored in a memory or storage medium and is executable by a processor or other logic, and a hardware configuration program useable for configuring a programmable hardware element. However, these are merely examples of a program and embodiments of the present invention are not limited in these respects.

The phrase “software program” as referred to herein is intended to include any type of program instructions, code, script and/or data, or combinations thereof, that may be stored in a storage medium and executed by a processor. Exemplary software programs include programs written in text-based programming languages, such as C, C++, Pascal, Fortran, Cobol, Java, assembly language, etc.; graphical programs (programs written in graphical programming languages); assembly language programs; programs that have been compiled to machine language; scripts; and other types of executable software. A software program may comprise two or more software programs that interoperate in some manner. However, these are merely examples of a software program and embodiments of the present invention are not limited in these respects.

The phrase “hardware configuration program” is intended to include a program or data structure that can be used to program or configure a programmable hardware element. However, these are merely examples of a hardware configuration program and embodiments of the present invention are not limited in these respects.

The phrase “programmable hardware element” as referred to herein is intended to include various types of programmable hardware, reconfigurable hardware, programmable logic, or field-programmable devices (FPDs), such as one or more FPGAs (Field Programmable Gate Arrays), or one or more PLDs (Programmable Logic Devices), such as one or more Simple PLDs (SPLDs) or one or more Complex PLDs (CPLDs), or other types of programmable hardware. A programmable hardware element may also be referred to as “reconfigurable logic”. A programmable hardware element may be configured using a hardware configuration program.

The phrase “machine-readable” instructions as referred to herein relates to expressions which may be understood by one or more machines for performing one or more logical operations. For example, machine-readable instructions may comprise instructions which are interpretable by a processor compiler for executing one or more operations on one or more data objects. However, this is merely an example of machine-readable instructions and embodiments of the present invention are not limited in this respect.

The phrase “storage medium” as referred to herein relates to media capable of maintaining expressions which are perceivable by one or more machines. For example, a storage medium may comprise one or more storage devices for storing machine-readable instructions or data. Such storage devices may comprise storage media such as, for example, optical, magnetic, flash, or semiconductor storage media. However, these are merely examples of a storage medium and embodiments of the present invention are not limited in these respects. Further, a ‘storage medium’ is also sometimes referred to as a memory medium, a machine-readable medium, a computer-readable medium, a processor-readable medium, etc., but for purposes of the present disclosure will be referred to only as ‘storage medium.’

The term “logic” as referred to herein relates to structure for performing one or more logical operations. For example, logic may comprise circuitry which provides one or more output signals based upon one or more input signals. Such circuitry may comprise a finite state machine which receives a digital input and provides a digital output, or circuitry which provides one or more analog output signals in response to one or more analog input signals. Such circuitry may be provided in an application specific integrated circuit (ASIC) or FPGA. Also, logic may comprise machine-readable instructions stored in a storage medium in combination with processing circuitry to execute such machine-readable instructions. However, these are merely examples of structures which may provide logic and embodiments of the present invention are not limited in this respect.

While the invention has been described in terms of several embodiments, those of ordinary skill in the art should recognize that the invention is not limited to the embodiments described, but can be practiced with modification and alteration within the spirit and scope of the appended claims. For example, reference herein to “one embodiment” or “an embodiment” means that a particular feature, structure, or characteristic described in connection with the embodiment is included in at least one embodiment of the invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments. The description is thus to be regarded as illustrative instead of limiting.

1. An article comprising:
a storage medium comprising machine-readable instructions stored thereon to:
execute a discoverable home network transcoder server to communicatively couple to a media server to receive media signals from the media server, to convert the media signals to a format compatible with more than one media renderers, and to transmit the converted signals to the more than one media renderers.

2. The article of claim 1 wherein the more than one media renderers comprise media renderers selected from the group consisting of a speaker, a video display, a video display/speaker combination, a flat panel monitor, a liquid crystal display screen, an audio speaker, a plasma screen television display, and a high definition television display.

3. The article of claim 1 wherein the discoverable home network transcoder server further comprises a transrating module.

4. The article of claim 1 wherein the discoverable home network transcoder server comprises a software module to execute on the media server.

5. The article of claim 4 wherein the software module further comprises a transrating module.

6. A system comprising:
a home network media server that provides signals representing media content;
at least one home network media renderer communicatively coupled to the home network media server that receives the signals representing the media content;
a discoverable home network transcoder server communicatively coupled to receive the signals representing the media content from the home network media server, to convert the signals representing the media content to a format compatible with the at least one home network media renderer, and to transmit the converted signals to the at least one home network media renderer; and
at least one antenna for communicating between the discoverable home network transcoder server and the at least one home network media renderer.

7. The system of claim 6 wherein the media content is selected from the group consisting of audio content, video content, and picture content.

8. The system of claim 6 wherein the at least one home network media renderer comprises a media renderer selected from the group consisting of a flat panel monitor, a liquid crystal display screen, an audio speaker, a plasma screen television display, and a high definition television display.

9. The system of claim 6 wherein the at least one home network media renderer comprises a plurality of media renderers.

10. The system of claim 9 wherein the plurality of media renderers comprise media renderers selected from the group consisting of at least one audio speaker, a video display, and a digital display.

11. A home network transcoder server comprising:
an input for receiving media signals from a media server in the home network;
circuitry for transcoding the media signals received at the input;
an output for providing transcoded signals back to the media server, the circuitry to transparently convert the media signals to a format compatible with at least one media renderer, and the circuitry to transmit the converted signals to the at least one media renderer.

12. The home network transcoder server of claim 11 further comprising a circuitry for transrating the media signals from the media server.

13. The home network transcoder server of claim 11 comprising a program for both transcoding and transrating the media signals that are received from the media server.

14. The home network transcoder server of claim 11 wherein the circuitry for transcoding media signals received from the media server comprises circuitry from the media server.

15. A method comprising:
incorporating a home network media renderer by a client of a home network, the client being a module in a web browser having a network application program that supports a first media file format for the home network media renderer;
encoding the home network media renderer in the first media file format to support media files of the first media file format;
requesting from a media server with the network application program of the client a media file of a second media file format; and
recognizing with a discoverable home network transcoder server that the media file is of the second media file format and converting the home network media renderer of the network application program to the second media file format prior to providing the media file to the web browser module of the client.

16. The method of claim 15 wherein the client comprises a graphical user interface to contact the media server.

17. The method of claim 15 wherein said incorporating the home network media renderer by the client comprises providing a list of available media renderers and selecting the home network media renderer from the list of available media renderers.

18. The method of claim 17 further comprising converting the selected home network media renderer to recognize the first media file format prior to passing the home network media renderer to the client.

19. A method comprising:
emulating a discoverable home network transcoder server for communicatively coupling to a media server to receive media signals from the media server, to transparently convert the media signals to a format compatible with at least one media renderer, and to transmit the converted signals to the at least one media renderer.

20. The method of claim 19 further comprising the transcoder server further emulating a transrating module.
